(19) United States
(12) Patent Application Publication
(10) Pub. No.: US 2019/0004204 A1
(43) Pub. Date: Jan. 3, 2019

(54) SYSTEM AND METHOD OF DETECTION OF AN OBJECT MADE WITH AN ELECTRICALLY POORLY CONDUCTIVE MATERIAL

(71) Applicant: Zheng Shi, Beijing (CN)

(72) Inventor: Zheng Shi, Beijing (CN)

(21) Appl. No.: 16/125,762

(22) Filed: Sep. 9, 2018

Related U.S. Application Data
(63) Continuation-in-part of application No. PCT/CN2017/076088, filed on Mar. 9, 2017.

(30) Foreign Application Priority Data
Mar. 11, 2016 (CN) 2016101406736

(51) Int. Cl. G01V 3/38; G01V 3/08; G06K 19/077; G06K 7/10

(52) U.S. Cl. CPC G01V 3/38; G06K 7/10366; G06K 19/07758; G01V 3/088

(57) ABSTRACT

The present invention provides an object that can be simultaneously detected by a capacitive sensor and an RFID reader, an object detection system and the accompanying method. The object includes a body made partially or entirely with an electrically poorly conductive material, and an RFID tag embedded in the body. The object detection system includes a processor, the object, a capacitive sensor, and an RFID reader. Once the object is placed within the detection range of the capacitive sensor, the capacitive sensor detects the object through capacitive coupling, and transmits the detected information to the processor. And once the object is placed within the detection range of the RFID reader, the RFID reader transmits an RF signal that passes through the electrically poorly conductive material to reach the RFID tag, detects the RFID tag, and transmits the detected information to the processor. The RFID reader detects the object before, during or after the capacitive sensor detects the object. The system can enhance capacitive coupling between the object and the capacitive sensor and reduce shielding of radio frequency identification, and thus improve the detection sensitivity.

### CROSS-REFERENCE TO RELATED APPLICATION

This application is a continuation in part of International Patent Application No. PCT/CN2017/076088, entitled “System and Method of Detection of an Object Made with an Electrically Poorly Conductive Material”, filed on Mar. 9, 2017, which claims priority of Patent Application CN2016101406736, entitled “Apparatus, System and Method for Detection of Objects”, filed on Mar. 11, 2016. The entire disclosure of the above application is incorporated herein by reference.

### TECHNICAL FIELD

The present invention provides an object that can be simultaneously detected by a capacitive sensor and an RFID reader, and the system and method for detection of the object. The present invention relates to radio frequency identification (RFID), capacitive sensing and electrically poorly conductive material.

### BACKGROUND

In some applications, it is needed to detect the presence of an object as well as an external object in contact with the object, and to recognize the identity of the object simultaneously. For these applications, an existing technical scheme is as follows: a capacitive sensor detects the object through capacitive coupling, and then an RFID reader detects the RFID tag through RF signal. The problem is that capacitive coupling and RF communication interfere with each other. The other problem is that once an external object is in contact with an object while the object remains stationary, the change of capacitive coupling of the object with a capacitive sensor tends to be small, compared to the magnitude of capacitance changes as a result of a finger touch upon the object.

In order to enhance capacitive coupling, an existing method is adding metal to the material of the object. The problem of this method, however, is that metal has shielding for RF communication, and RF signals have interference with capacitive coupling of metal. In the present invention, the object is made partially or entirely with an electrically poorly conductive material, which would enhance capacitive coupling between the object and the capacitive sensor and reduce shielding of radio frequency identification, and thus improve the detection sensitivity.

### SUMMARY OF THE INVENTION

Aiming to solve the problems above, the present invention provides an object that can be simultaneously detected by a capacitive sensor and an RFID reader. The object includes a body that is made partially or entirely with an electrically poorly conductive material and an RFID tag embedded in the body.

Electrically poorly conductive material, e.g., conductive plastic, has been widely used. The resistance for a piece of such material with a length of one centimeter is about 10⁴˜10⁶ ohms. The electrically poorly conductive material is used to enhance capacitive coupling with objects, especially for a finger touch on the objects. In the present invention, the electrically poorly conductive material exists in between RFID tags and an RFID reader, which however doesn't block the RFID reader from detecting the RFID tags. In other words, the electrically poorly conductive material doesn't significantly screen the transmission of RF signals, and it is electrically conductive. In particular, when the electrically poorly conductive material extends from one side to another side of the body, the change of charges at one side of the body can be transmitted to another side. If one side of the object has already capacitively coupled with the capacitive sensor, upon a finger touch on the other side of the object, the change of capacitance will be sensed, which enables the detection of this touch action.

In accordance with one embodiment of the present invention, the electrically poorly conductive material extends from one side of the body to another side of the body, either through the interior of the body or a surface of the body, when the object that is made partially with the electrically poorly conductive material.

In accordance with one embodiment of the present invention, the body has a structure that includes two layers, and the RFID tag is placed between the two layers.

In accordance with one embodiment of the present invention, the body has a pen structure that includes a nib and a holder, and the holder is controlled by hand and the nib is used in contact with a capacitance sensing surface.

In accordance with one embodiment of the present invention, the present invention provides an object detection system. The system includes a processor, an object that can be simultaneously detected by a capacitive sensor and an RFID reader, a capacitive sensor, and an RFID reader. The object includes a body made partially or entirely with an electrically poorly conductive material, and an RFID tag embedded in the body. Once the object is placed within the detection range of the capacitive sensor, the capacitive sensor detects the object through capacitive coupling, and transmits the detected information to the processor. And once the object is placed within the detection range of the RFID reader, the RFID reader transmits an RF signal that passes through the electrically poorly conductive material to reach the RFID tag, detects the RFID tag, and transmits the detected information to the processor. The RFID reader detects the object before, during or after the capacitive sensor detects the object.

In accordance with one embodiment of the present invention, once the capacitive sensor has detected the object with the electrically poorly conductive material, a first capacitive coupling value is generated and transmitted to the processor. And once an external object is in contact with the object while the object remains stationary, the capacitive sensor senses the external object through the electrically poorly conductive material, and a second capacitive coupling value is generated and transmitted to the processor. If the second capacitive coupling value is greater than the first capacitive coupling value, the processor derives that an external object has been in contact with the object. If the second capacitive coupling value is equal to the first capacitive coupling value, the processor is derives that no external object has been in contact with the object.

In accordance with one embodiment of the present invention, the present invention provides an object detection method, including the following steps:

placing an object within the detection range of a capacitive sensor, and the object has a body made partially or entirely with an electrically poorly conductive material, and an RFID tag embedded in the body;

detecting the object by the capacitive sensor, and transmitting the detected information to a processor;

placing the object within the detection range of an RFID reader;

transmitting, by the RFID reader, an RF signal that passes through the electrically poorly conductive material, detecting the RFID tag, and transmitting the detected information to the processor;

the action of RFID reader detecting the object happens before, during or after the action of capacitive sensor detecting the object.

With the design above, the object detection system can detect not only objects, but also external forces exerted upon the objects.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is a schematic diagram illustrating the object placing on the capacitive sensor and the RFID reader in accordance with one embodiment of the present invention.

FIG. 2 is a cross-section diagram of the electrically poorly conductive material extending from one side of the body to another side of the body in accordance with one embodiment of the present invention.

FIG. 3 is a schematic diagram illustrating the body with a two-layer structure in accordance with one embodiment of the present invention.

FIG. 4 is a schematic diagram illustrating the body with a pen structure in accordance with one embodiment of the present invention.

FIG. 5 is a schematic diagram illustrating an external object in contact with the object in accordance with one embodiment of the present invention.

FIG. 6 is a flow chart illustrating the object detection method in accordance with one embodiment of the present invention.

FIG. 7 is a flow chart illustrating the generating a first capacitive coupling value in accordance with one embodiment of the present invention.

FIG. 8 is a flow chart illustrating the generating a second capacitive coupling value in accordance with one embodiment of the present invention.

### DETAILED DESCRIPTION OF THE INVENTION

Reference will now be made in detail to various embodiments of the invention illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

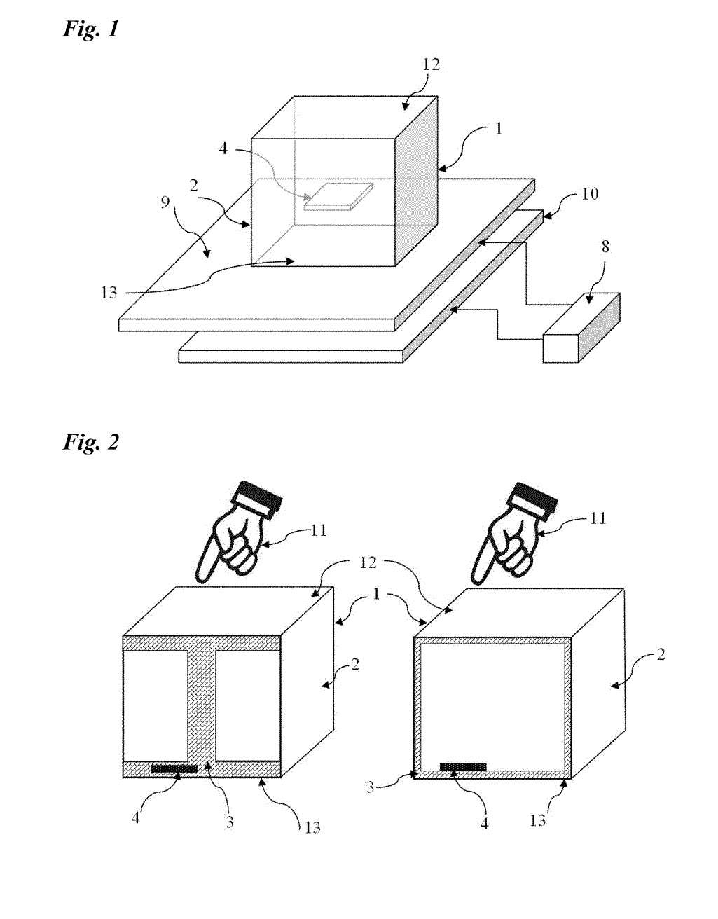

The present invention discloses an object 1 that can be simultaneously detected by a capacitive sensor and an RFID reader. As shown in FIG. 1, the object includes a body 2 that is made partially or entirely with an electrically poorly conductive material 3, and an RFID tag 4 embedded in the body 2.

Once the body 2 of the object 1 is made partially with the electrically poorly conductive material 3, as shown in FIG. 2, the electrically poorly conductive material 3 extends from one side 12 of the body 2 to another side 13 of the body 2, either through the interior of the body 2 or a surface of the body 2. As shown in FIG. 2, the side 13 is the opposite end of the side 12 in the body 2.

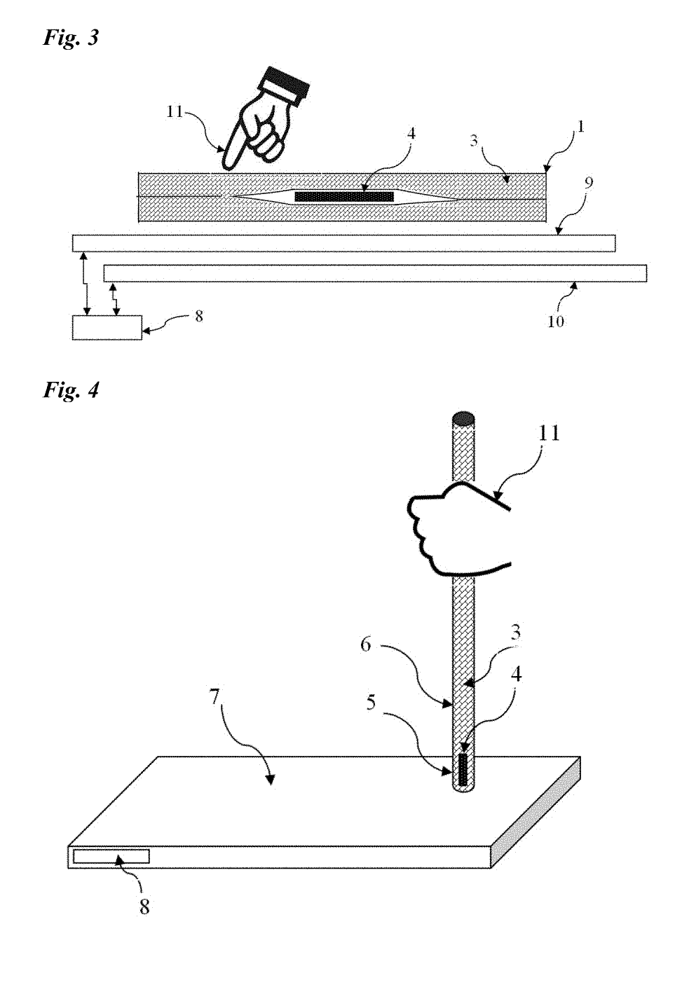

The body 2 could have a structure including two layers, and the RFID tag 4 is placed between the two layers, as shown in FIG. 3.

As shown in FIG. 4, the body 2 could also include a pen structure that has a nib 5 and a holder 6. The holder 6 is controlled by hand and the nib 5 is used in contact with a capacitance sensing surface 7 which could further receive and process the detected information resulting from the touch.

The present invention provides an object detection system, as shown in FIG. 1. The system includes a processor 8, the object 1, a capacitive sensor 9, and an RFID reader 10.

The object 1 can be simultaneously detected by the capacitive sensor 9 and the RFID reader 10, and includes the body 2 made partially or entirely with the electrically poorly conductive material 3, and the RFID tag 4 embedded in the body.

Once the object 1 is placed within the detection range of the capacitive sensor 9, the capacitive sensor 9 detects the object 1 through capacitive coupling, and transmits the detected information to the processor 8.

Once the object 1 is placed within the detection range of the RFID reader 10, the RFID reader 10 transmits an RF signal that passes through the electrically poorly conductive material 3 to reach the RFID tag 4, detects the RFID tag 4, and transmits the detected information to the processor 8.

The RFID reader 10 detects the object 1 before, during or after the capacitive sensor 9 detects the object 1.

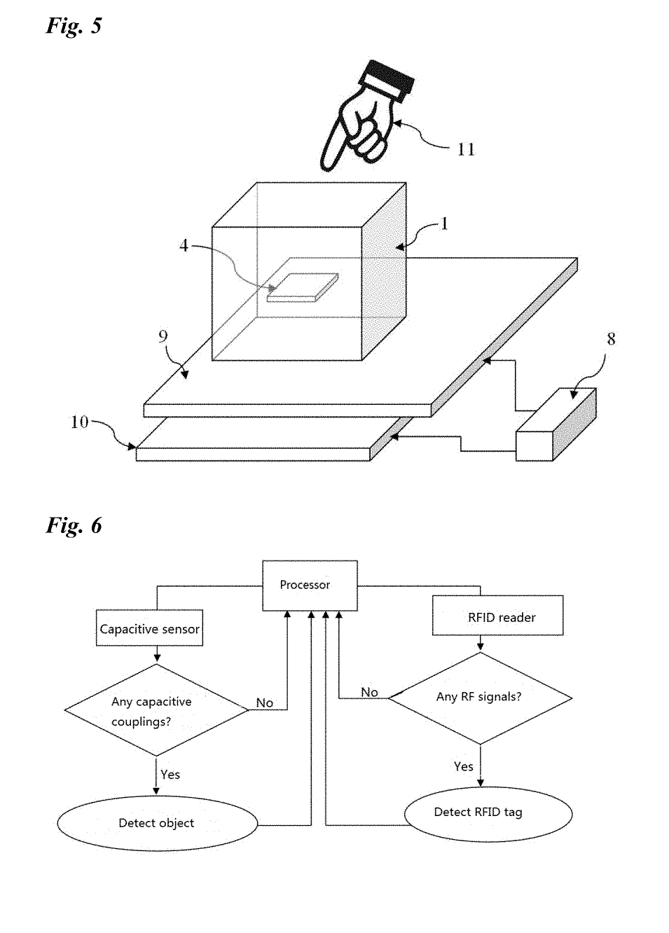

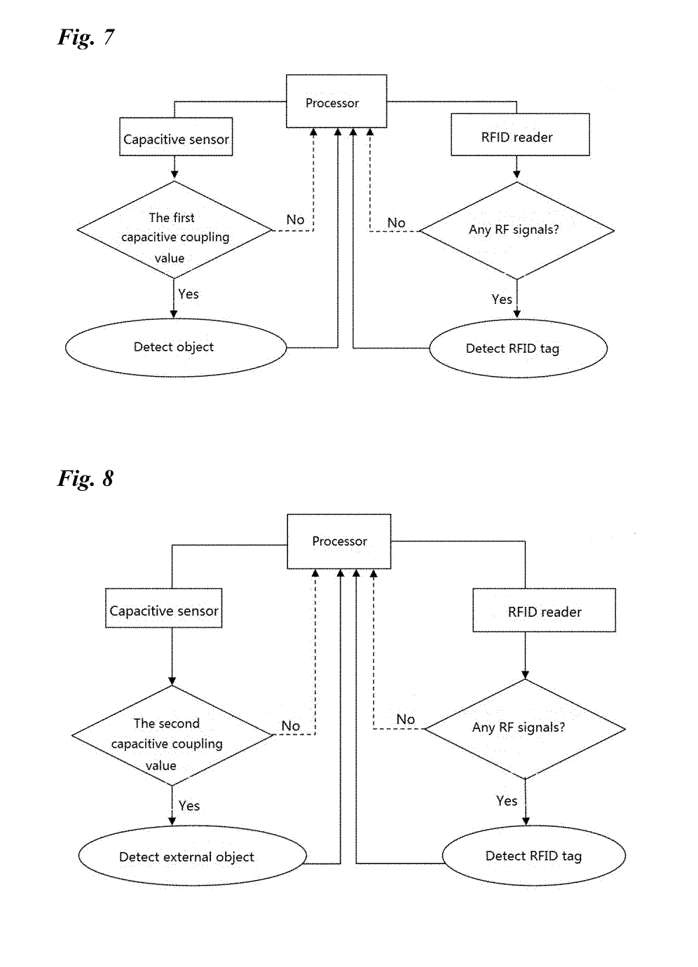

Once the capacitive sensor 9 has detected the object 1 with the electrically poorly conductive material 3, a first capacitive coupling value is generated and transmitted to the processor 8, as shown in FIG. 7. And once an external object 11 is in contact with the object 1 while the object 1 remains stationary, as shown in FIG. 5, the capacitive sensor 9 senses the external object 11 through the electrically poorly conductive material 3, and a second capacitive coupling value is generated and transmitted to the processor 8. If the second capacitive coupling value is greater than the first capacitive coupling value, the processor 8 derives that an external object has been in contact with the object 1. If the second capacitive coupling value is equal to the first capacitive coupling value, the processor is derives that no external object has been in contact with the object 1.

The present invention provides an object detection method, as shown in FIG. 6, including the following steps:

placing the object 1 within the detection range of the capacitive sensor 9, an, wherein, and the object 1 includes the body 2 made partially or entirely with the electrically poorly conductive material 3, and an RFID tag 4 embedded in the body 2;

detecting the object 1 by the capacitive sensor 9 through capacitive coupling, and transmitting the detected information to the processor 8;

placing the object 1 within the detection range of the RFID reader 10;

transmitting, by the RFID reader 10, an RF signal that passes through the electrically poorly conductive material 3, detecting the RFID tag 4, and transmitting the detected information to the processor 8;

the action of RFID reader 10 detecting the object 1 happens before, during or after the action of capacitive sensor 9 detecting the object 1.

As shown in FIG. 7, once the capacitive sensor 9 has detected the object 1 with the electrically poorly conductive material 3, a first capacitive coupling value is generated and transmitted to the processor 8. And as shown in FIG. 8, once the external object 11 is in contact with the object 1 while the object 1 remains stationary, the capacitive sensor 9 senses the external object 11 through the electrically poorly conductive material 3, and a second capacitive coupling value is generated and transmitted to the processor 8. If the second capacitive coupling value is greater than the first capacitive coupling value, the processor 8 derives that an external object has been in contact with the object 1. If the second capacitive coupling value is equal to the first capacitive coupling value, the processor is derives that no external object has been in contact with the object 1.

1. An object that can be simultaneously detected by a capacitive sensor and an RFID reader, comprising:
a body, made partially or entirely with an electrically poorly conductive material;
an RFID tag, embedded in the body.

2. The object of claim 1, wherein the electrically poorly conductive material extends from one side of the body to another side of the body, through either the interior of the body or a surface of the body, for an object that is made partially with the electrically poorly conductive material.

3. The object of claim 1, wherein the body assumes a structure comprising two layers, and the RFID tag is placed between the two layers.

4. The object of claim 1, wherein the body assumes a pen structure comprising a nib and a holder, and wherein the holder is controlled by hand and the nib is used in contact with a capacitance sensing surface.

5. An object detection system, comprising:
a processor;
an object that can be simultaneously detected by a capacitive sensor and an RFID reader, wherein the object comprises a body made partially or entirely with an electrically poorly conductive material, and an RFID tag embedded in the body;
a capacitive sensor, wherein upon the object being placed within the detection range of the capacitive sensor, the capacitive sensor detects the object through capacitive coupling, and transmits the detected information to the processor;
an RFID reader, wherein upon the object being placed within the detection range of the RFID reader, the RFID reader transmits an RF signal that passes through the electrically poorly conductive material to reach the RFID tag, detects the RFID tag, and transmits the detected information to the processor;
wherein, the RFID reader detects the object before, during or after the capacitive sensor detects the object.

6. The system of claim 5, wherein, upon the capacitive sensor having detected the object with the electrically poorly conductive material, a first capacitive coupling value is generated and transmitted to the processor; and wherein, upon an external object being in contact with the object while the object remains stationary, the capacitive sensor senses the external object through the electrically poorly conductive material, and a second capacitive coupling value is generated and transmitted to the processor; and
wherein, if the second capacitive coupling value is greater than the first capacitive coupling value, the processor is configured to derive that an external object has been in contact with the object; and
wherein, if the second capacitive coupling value is equal to the first capacitive coupling value, the processor is configured to derive that no external object has been in contact with the object.

7. An object detection method, comprising:
placing, within the detection range of a capacitive sensor, an object, wherein, the object comprises a body made partially or entirely with an electrically poorly conductive material, and an RFID tag embedded in the body;
detecting the object by the capacitive sensor, and transmitting the detected information to a processor;
placing, within the detection range of an RFID reader, the object;
transmitting, by the RFID reader, an RF signal that passes through the electrically poorly conductive material, detecting the RFID tag, and transmitting the detected information to the processor;
wherein, the action of RFID reader detecting the object happens before, during or after the action of capacitive sensor detecting the object.

8. The method of claim 7, further comprising:
detecting the object by the capacitive sensor, wherein a first capacitive coupling value is generated and transmitted to a processor;
placing an external object in contact with the object while the object remains stationary;
detecting, by the capacitive sensor, the external object through the electrically poorly conductive material, wherein a second capacitive coupling value is generated and transmitted to the processor;
comparing, by the processor, the first capacitive coupling value with the second capacitive coupling value;
deriving, by the processor, that an external object has been in contact with the object, upon the comparison result being that the second capacitive coupling values is greater than the first capacitive coupling values; deriving, by the processor, that no external object has been in contact with the object, upon the two capacitive coupling values being equal.
